(19) United States
(12) Patent Application Publication
(10) Pub. No.: US 2011/0141379 A1
(43) Pub. Date: Jun. 16, 2011

(54) TELEVISION RECEIVER AND METHOD FOR DRIVING TELEVISION RECEIVER

(75) Inventors: Hideki Ichioka, Osaka (JP); Toshiharu Kusumoto, Osaka (JP); Kenji Nishida, Osaka (JP)

(73) Assignee: Sharp Kabushiki Kaisha, Osaka-shi, Osaka (JP)

(21) Appl. No.: 12/737,817

(22) PCT Filed: May 22, 2009
(86) PCT No.: PCT/JP2009/059448

§ 371 Date: Feb. 18, 2011

(30) Foreign Application Priority Data
Aug. 26, 2008 (JP) 2008-217432

(51) Int. Cl. H04N 5/64

(52) U.S. Cl. 348/841; 348/E05.128

(57) ABSTRACT

A decorative image is displayed in a decorative image display region; a decorative frame is displayed in a peripheral section of the decorative image so that the decorative frame includes at least one color that is in a same range as a color of a frame structure. This makes it possible (i) to make the frame structure that is an actual part of a television receiver less conspicuous and (ii) also to display a decorative image as though the decorative image had a real frame. Consequently, it becomes possible to realize a television receiver that can be used as a part of an interior.

### TECHNICAL FIELD

The present invention relates to a television receiver employing a display mode that makes a frame structure that is an actual part of the television receiver less conspicuous, while displaying a decorative image such as a painting or photograph on a display region of the television receiver, and relates to a method for driving such a television receiver.

### BACKGROUND ART

In recent years, development of electronic apparatuses and like apparatuses for home use which can be utilized as a part of an interior of the home have been increasing in demand; such apparatuses serve as interior by making good use of their design while the apparatuses are not being used.

Among such apparatuses, television receivers have increased in their presence due to the recent development in size, and hence the foregoing demand of developing the apparatuses utilizable as a part of the interior is increasing even more.

On this account, attempts have been made with the television receiver to improve their interior usability, for example by allowing color selection of their frame structure.

However, this attempt can only achieve so much in improving the interior usability of the television receiver; it is the display region that occupies most part of the appearance of the television receiver, which display region gives the strongest impression.

Accordingly, improvement in relation to the display region of the television receiver is in high demand.

The following description specifically explains this point, by use of, as an example, a television receiver in which the display region is made up of a screen of a liquid crystal display device.

A television receiver in which the liquid crystal display device is used can be provided on the wall due to its light weight and its thin thickness.

The liquid crystal display device has an entirely black screen while its display is turned off.

Consequently, while the television receiver disposed on the wall is turned off, the wall will have a black object thereon.

This black object spoils the interior. Due to the enlargement of recent television receivers, the interior is spoiled even more than before.

In view of this, the television receiver further requires to employ a mode that displays a decorative image or the like, other than its original function to display image data such as broadcasting and video. This allows the television receiver to be utilized as a part of the interior while the television receiver is not used by the original function.

Moreover, in order to improve the interior usability, it is necessary to further make a frame structure that is an actual part of the television receiver less conspicuous while the decorative image or the like is displayed.

Displays for interior decoration that use a flat type of display means have been conventionally available as an interior item, for example upon consideration of inconvenience in using a real painting as an interior decoration (e.g., being troublesome to replace pictures, requiring space for storing an unused painting, and compatibility of the painting with the frame).

For instance, Patent Literature 1 discloses an interior decoration display that uses a liquid crystal display device as the flat type of display means.

Illustrated in (a) of FIG. 10 is a perspective view of the interior decoration display when seen from its front side, and (b) of FIG. 10 is a cross-sectional view of a display section of the interior decoration display.

As illustrated in (a) and (b) of FIG. 10, a liquid crystal display section 220 includes: a display unit 221 having a backlight 221a provided on its rear side and a dot-matrix liquid crystal panel 221b provided on its front side; a transparent protection panel 222 attached on the front side of the display unit 221; and a casing 223 that covers the protection panel 222 and display unit 221 around their sides and rear. The casing 223 has an opening that matches in shape with the external shape of the protection panel 222. A peripheral part of the liquid crystal panel 221b has a driving circuit (source driver or gate driver) for driving the liquid crystal panel 221b; such a region serves as a non-display region. Hence, with the interior decoration display, the protection panel 222 provided on the front side of the liquid crystal panel 221b have a peripheral part on which its surface is shaped as a lens, by having its cut plane bent. Such a configuration allows none of the non-display region in the peripheral part of the liquid crystal panel 221b be visible and displays the peripheral part of the display region of the liquid crystal panel 221b in an enlarged manner, in cases where the liquid crystal display section 220 is seen from various angles from the front. Therefore, if a frame pattern is displayed in the peripheral part of the liquid crystal panel 221b, the frame pattern is displayed in an enlarged manner to fill the whole frame section, due to the effect of the lens-shaped part of the protection panel 222.

Moreover, a power source section 240 is connected to a commercial AC power supply, to supply direct-current electrical power that is required by the liquid crystal display section 220. Further, the power source section 240 supports the liquid crystal display section 220 in a suspended manner, via two suspension wires 241 and 241.

With the interior decoration display of the foregoing configuration, it is possible to make the non-display region in the peripheral part of the liquid crystal panel 221b not visible, while freely changing a decorative images such as a painting and a frame pattern being displayed in the display region and combining the decorative image with the frame pattern. Hence, the interior decoration display serves as an excellent display for interior decoration use.

### CITATION LIST

### Patent Literature

### Patent Literature 1

Japanese Patent Application Publication, Tokukaihei, No. 10-260654 A (Publication Date: Sep. 29, 1998)

### SUMMARY OF INVENTION

### Technical Problem

Meanwhile, although the interior decoration display disclosed in Patent Literature 1 has an advantage that the non-display region of the peripheral part of the liquid crystal display 221b is made not visible by the lens-shaped part provided on the peripheral part of the protection panel 222 as described above, this display has a problem that an image displayed in the peripheral section of the display region is displayed in a distorted manner.

In the case of the display for interior decoration, the peripheral section of the display region serves as a frame display region, so even though the image displayed therein is distorted, this distorted display does not particularly become a problem.

However, if the lens-shaped configuration of Patent Literature 1 is used with a television receiver that employs a mode to display a decorative image on the television receiver so that the television receiver can be utilized as a part of the interior, a major problem occurs that when regular television is viewed, an image displayed in the peripheral section of the display region is displayed in a distorted manner.

Hence, although the lens-shaped configuration of Patent Literature 1 is applicable for a display exclusively for decoration purposes, it is not applicable to a television receiver that employs both the decoration and viewing uses.

Further, Patent Literature 1 is configured such that a non-display region is put out of view by using a lens. Accordingly, the configuration of Patent Literature 1 is not designed for the purpose of making a frame structure that is an actual part of the television receiver less conspicuous.

The present invention is accomplished in view of the foregoing problem, and its object is to provide a television receiver and a method for driving a television receiver, which television receiver is capable of (i) making the frame structure that is an actual part of the television receiver less conspicuous which frame structure is essential in view of durability and the like of the television receiver and (ii) displaying a decorative image such as a painting or photograph as though the decorative image had a real frame while displaying the decorative image on a display region section of the television receiver, so that the television receiver can be utilized as a part of the interior.

### Solution to Problem

In order to attain the object, a television receiver of the present invention includes: a frame structure; and a display region surrounded by the frame structure, displaying an image, the display region, while displaying a decorative image, displaying a decorative frame on a peripheral section of the decorative image, the decorative frame including at least one color that is in a same range as a color of the frame structure.

Moreover, in order to attain the object, a method of the present invention for driving a television receiver including: a frame structure; and a display region surrounded by the frame structure, displaying an image, includes: causing the display region to display, while the display region displays a decorative image, a decorative frame on a peripheral section of the decorative image; and causing the decorative frame to include at least one color that is in a same range as a color of the frame structure.

According to the configuration, while a decorative image such as a painting or photograph is displayed in the display region, both (i) the actual frame structure of the television receiver, which frame structure is an essential configuration in view of durability of the television receiver and (ii) a decorative frame displayed on a peripheral section of the decorative image, are visible as a frame of the decorative image.

Meanwhile, by having at least one color of the decorative frame be of a color in a same color range as at least one color of the frame structure, it is possible to cause the frame structure and the decorative frame to appear to a viewer as though they were assimilated with each other.

Namely, a color of the decorative frame is made to be a color close to that of the frame structure, in order to have the actual frame structure be perceived as being integrated with the decorative frame. This results in making the frame structure less conspicuous.

In view from another aspect, for example, in a case where a color and/or a two-dimensional or three-dimensional pattern of a preferable decorative frame is conceived in accordance with a decorative image, a viewer of the television receiver feel awkward if a color of the frame is quite different from the conceived color of the preferable decorative frame. This is because the viewer sees a frame structure that appears different in a visual aspect from the decorative frame, on an outer side of the decorative frame.

In this regard, according to the above configuration, the decorative frame includes at least one color that is in a same range as a color of the frame structure. Therefore, it is possible to reduce the awkward feeling of awkwardness in a viewer of the television receiver which feeling is caused by the frame structure.

In the specification, to have at least one color of the decorative frame be in a same color range as at least one color of the frame structure denotes that a color in a same range of at least one color included in the frame structure is included as at least one color of the colors included the decorative frame, or that a color in a same range of at least one color included in the decorative frame is included as at least one color of the colors included in the frame structure.

Moreover, colors that are in the same range means that the colors have a hue in common. For example, colors that are in the same range as red include all colors that include red as a common hue, such as red, reddish purple, red purple, purplish red, yellowish red, yellow red, and reddish yellow. Moreover, achromatic colors such as white, gray, and black are all colors in a same range.

Hence, by the above configuration, it is possible to achieve a television receiver and a method for driving a television receiver, each of which allows, a frame structure to be less conspicuous while a display region of the television receiver displays a decorative image, and a frame of the decorative image to be shown so that it looks more real.

The decorative image denotes an image provided for decorative purposes, such as a painting or a photograph. In the specification, a painting denotes a picture drawn or printed on for example a piece of paper or canvas. Moreover, a photograph denotes a photographed object that is printed on for example a piece of paper.

Moreover, the decorative image is an image displayed upon selection of a picture mode for example by a viewer of the television receiver, which picture mode is a mode displaying the decorative image to utilize the television receiver as a part of the interior.

Moreover, with the television receiver of the present invention, it is preferable that the color that is in a same range is a hue adjacent in position on a Munsell hue circle having ten hues, from among the ten hues in the Munsell hue circle.

Moreover, with the method of the present invention for driving the television receiver, it is preferable that the color that is in a same range is to be a hue adjacent in position on the Munsell hue circle having ten hues, from among the ten hues in the Munsell hue circle.

Colors in the same range in the foregoing configuration are determined based on the Munsell hue circle having ten hues, and are hues that are located adjacent to each other. For example, colors in a same range as purple is, according to the Munsell hue circle having ten hues, red purple and blue purple.

According to the configuration, a color of the decorative frame and a color of the frame structure are colors that belong to a same range. Hence, it is possible to make the frame structure less conspicuous.

Therefore, by the above configuration, it is possible to achieve a television receiver and a method for driving a television receiver, each of which allows a frame structure to be less conspicuous while a display region of the television receiver displays a decorative image, and a frame of the decorative image to be shown so that it looks more real.

Note that the Munsell hue circle is classified by numbers and symbols based on hue, one of the three attributes of color. The Munsell color system is employed in JIS specification (JIS Z 8721) as a “Specification according to their three attributes”. Details thereof are described later.

With the television receiver of the present invention, it is preferable that the color that is in a same range is a same hue on a Munsell hue circle having ten hues, from among the ten hues in the Munsell hue circle.

Moreover, with the method of the present invention for driving a television receiver, it is preferable that the color that is in a same range is to be a same hue on a Munsell hue circle having ten hues, from among the ten hues in the Munsell hue circle.

According to the configuration, the color of the decorative frame and the color of the frame structure are colors of a same hue among the ten hues of the Munsell hue circle. Hence, it is possible to further make the frame structure less conspicuous.

Therefore, by the foregoing configuration, it is possible to achieve a television receiver and a method for driving a television receiver, each of which allows a frame structure to be less conspicuous while a display region of the television receiver displays a decorative image, and a frame of the decorative image to be shown so that it looks more real.

With the television receiver of the present invention, it is preferable that the color that is in a same range is an achromatic color.

Moreover, with the method of the present invention for driving a television receiver, it is preferable that the color that is in a same range is to be an achromatic color.

According to the configuration, the color of the decorative frame and the color of the frame structure are achromatic colors such as white, gray, and black, which colors are of a same range.

Therefore, by having such a configuration, it is possible to have the frame be configured so that it suits well to, for example, a black and white decorative image.

Moreover, with the television receiver of the present invention, it is preferable that the color that is in a same range has a same color value.

Moreover, with the method of the present invention for driving a television receiver, it is preferable that the color that is in a same range is to have a same color value.

According to the configuration, a color value (brightness), which is an attribute of color regarding relative brightness of an object surface, is the same. Hence, it is possible to further make the frame structure less conspicuous.

With the television receiver of the present invention, it is preferable that the decorative frame has a width of not less than onefold of a width of the frame structure.

Moreover, with the method of the present invention for driving the television receiver, it is preferable that the decorative frame is to have a width of not less than onefold of a width of the frame structure.

According to the configuration, while the decorative image is displayed in the display region, both the frame structure and the decorative frame serve as the frame of the decorative image. The frame structure is essential in view of durability of the television receiver and is an actual part of the television receiver.

Further, by having the width of the decorative frame be not less than onefold of the width the frame structure, the frame structure is made less conspicuous.

Namely, the decorative frame is conspicuous as the frame of the decorative image.

Hence, by the foregoing configuration, it is possible to achieve a television receiver and a method for driving a television receiver, each of which allows a frame structure to be less conspicuous while a display region of the television receiver displays a decorative image, and a frame of the decorative image to be shown so that it looks more real.

Moreover, with the television receiver of the present invention, it is preferable that the width of the decorative frame is not more than fivefold of the width of the frame structure.

Moreover, with the method of the present invention for driving the television receiver, it is preferable that the width of the decorative frame is to be not more than fivefold of the width of the frame structure.

As described above, the width of the frame structure is less conspicuous by having the width of the decorative frame be not less than onefold of the width of the frame structure.

However, if the width of the decorative frame is too thick, proportion of the frame is too high with respect to the size of the decorative image. As a result, a viewer generates a feel of awkwardness to the picture, and further appearance of the picture is remarkably spoiled.

Meanwhile, as in the foregoing configuration, by having the decorative frame be of a width not more than fivefold of the width of the frame structure, it is possible to make the width of the frame structure less conspicuous and further prevent the width of the decorative frame from becoming too wide. This allows achievement of a television receiver and a method for driving a television receiver that can maintain its good appearance.

Moreover, with the television receiver of the present invention, it is preferable that the frame structure has a width in a range from not less than 5 mm to not more than 85 mm.

If the width of the frame structure is not more than 5 mm, the frame structure lacks in strength, thereby making it difficult to achieve a durable television receiver.

On the other hand, if the width of the frame structure is not less than 85 mm, this spoils the good appearance of the television receiver.

Therefore, by providing the frame structure so as to have a width ranging from not less than 5 mm to not more than 85 mm as in the foregoing configuration, it is possible to achieve a durable television receiver while still maintaining its good appearance.

With the television receiver of the present invention, it is preferable that: between the decorative image and the decorative frame, a blank image is further displayed.

With the method of the present invention for driving the television receiver, it is preferable that: between the decorative image and the decorative frame, a blank image is further displayed.

According to the above configuration, between the decorative image and the decorative frame, a blank image is further displayed. This makes it possible to display the decorative image so that the decorative image looks more real.

In other words, for example, with a decorative image such as a woodblock print which appears more natural by having a blank in its peripheral section, use of this configuration allows attaining a display of the decorative image that is further close to a real picture.

Therefore, it becomes possible to realize a television receiver and a method for driving the television receiver, each of which makes it possible to display the decorative image so that the decorative image looks more real.

For example, in a case where the decorative image is a painting, a blank painting paper can be displayed as the blank image; in a case where the decorative image is a photograph, a blank printing paper can be displayed as the blank image. These examples are merely exemplifications and the present invention is not limited to these.

With the television receiver of the present invention, it is preferable that the surface luminance of the display region in which the decorative image is displayed is not more than 50 cd/m².

Further, with the television receiver of the present invention, it is preferable that the surface luminance of the display region in which the blank image is displayed is not more than 50 cd/m².

Moreover, with the method of the present invention for driving a television receiver, it is preferable that the surface luminance of the display region in which the decorative image is displayed is to be not more than 50 cd/m².

Moreover, with the method of the present invention for driving a television receiver, it is preferable that the surface luminance of the display region in which the blank image is displayed is to be not more than 50 cd/m².

According to the configuration, the display region in which the decorative image is displayed has an extremely low surface luminance. This causes the viewer of the television receiver to feel as though the viewer were viewing not a luminous color but a reflected color. In other words, it is possible to cause the viewer to feel as though the viewer were viewing not an image displayed on a screen but a real picture drawn or painted on a piece of paper or the like.

Moreover, the surface luminance of the display region of the blank image between the decorative image and the decorative frame can be set at a very low luminance.

The above configuration makes it possible to realize a television receiver and a method for driving the television receiver, each of which can make the decorative image and the blank image look more real.

With the television receiver of the present invention, it is preferable that the surface luminance is not more than 30 cd/m².

Moreover, with the method of the present invention for driving a television receiver, it is more preferable that the surface luminance is to be not more than 30 cd/m².

According to the configuration, the surface luminance is not more than 30 cd/m²; even if an external light luminance is dark, for example of not more than 100 cd/m², it is still possible to have the viewer sense as though the viewer were viewing a real picture in which the decorative image and the blank image each displayed in the display region had been drawn or painted on a piece of paper or the like.

Therefore, it is possible to achieve a television receiver and a method for driving a television receiver, each of which is capable of displaying the decorative image and the blank image so that they look more real, even in a dark place.

### Advantageous Effects of Invention

As described above, the television receiver of the present invention, while the display region displays a decorative image, displays a decorative frame in a peripheral section of the decorative image, and the decorative frame includes at least one color that is in a same range as a color of the frame structure.

Moreover, as described above, a method of the present invention for driving a television receiver is a method in which, while the display region displays the decorative image, the display region is caused to display a decorative frame in a peripheral section of the decorative image, and the decorative frame includes at least one color that is in a same range as a color of the frame structure.

This attains an effect of making the frame structure less conspicuous which frame structure is an actual part of the television receiver and which frame structure is essential in consideration of durability and the like of the television receiver, in a case where a decorative image such as a painting or photograph is displayed in a display region of the television receiver. In addition, the above configuration attains an effect of providing a television receiver and a method for driving the television receiver which displays the decorative image as though the decorative image had a real frame, so that the television receiver can be utilized as a part of the interior.

### BRIEF DESCRIPTION OF DRAWINGS

FIG. 1 is a view illustrating one example of a liquid crystal television receiver of one embodiment of the present invention, which television receiver is in a picture mode and is hung on a wall; (a) illustrates a case where a decorative frame has each width twofold of each corresponding width of a frame structure, and (b) illustrates a case where the decorative frame has each width fivefold of each corresponding width of the frame structure.

FIG. 2 is a view illustrating another example of a liquid crystal television receiver of one embodiment of the present invention, which television receiver is in a picture mode and is hung on a wall; (a) illustrates a case where a decorative frame has each width twofold of each corresponding width of a frame structure, and (b) illustrates a case where the decorative frame has each width fivefold of each corresponding width of the frame structure.

FIG. 3 is a view illustrating still another example of a liquid crystal television receiver of one embodiment of the present invention, which television receiver is in a picture mode and is hung on a wall; (a) illustrates a case where a decorative frame has each width twofold of each corresponding width of a frame structure, and (b) illustrates a case where the decorative frame has each width fivefold of each corresponding width of the frame structure.

FIG. 4 is a view illustrating still another example of a liquid crystal television receiver of one embodiment of the present invention, which television receiver is in a picture mode and is hung on a wall.

FIG. 5 is a view illustrating still another example of a liquid crystal television receiver of one embodiment of the present invention, which television receiver is in a picture mode and is hung on a wall.

FIG. 6 is a view illustrating a Munsell hue circle having 20 hues.

FIG. 7 illustrates an embodiment of the present invention, and is a block diagram schematically illustrating a configuration of a liquid crystal display device.

FIG. 8 illustrates an embodiment of the present invention, and is a block diagram related to luminance control.

FIG. 9 illustrates an embodiment of the present invention, and is a view illustrating a flowchart related to luminance control.

FIG. 10 is a view illustrating a conventional interior decoration display; (a) is a perspective view when the conventional interior decoration display is seen from its front side, and (b) is a cross-sectional view of a display section.

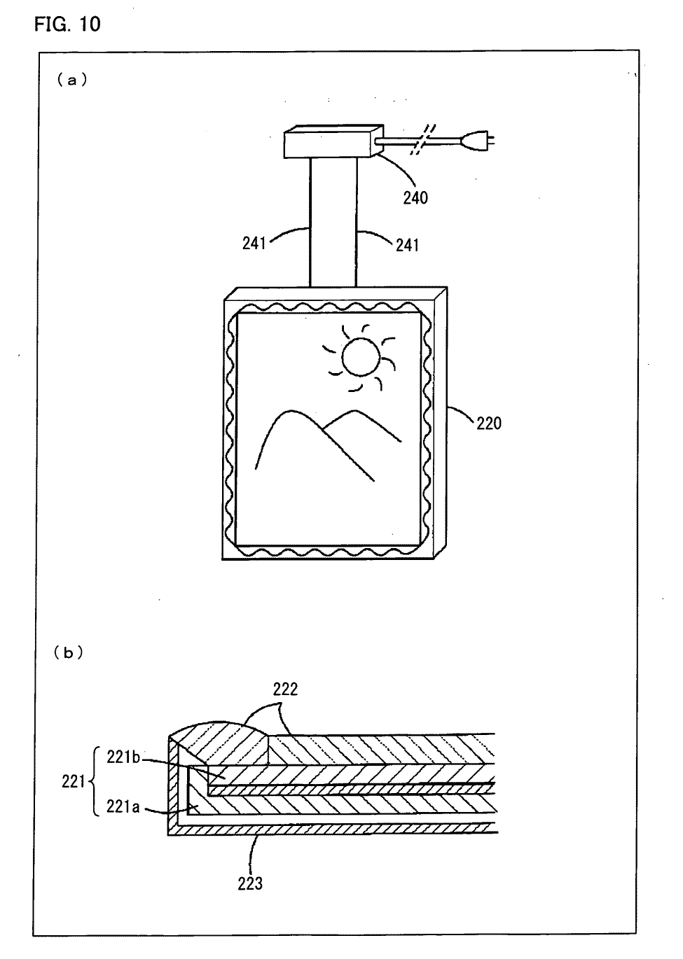

### DESCRIPTION OF EMBODIMENTS

The following description specifically explains one embodiment of the present invention by use of a liquid crystal television receiver as an example of a television receiver, in which a display region is made of a screen of a liquid crystal display device.

A liquid crystal television receiver in which this liquid crystal display device is used can be provided on the wall due to its light weight and its thin thickness.

However, the liquid crystal display device has an entirely black display surface while its display is turned off. Consequently, while the television receiver disposed on the wall is turned off, the wall will have a black object thereon.

This black object spoils the interior. Due to the enlargement of recent television receivers, the interior is spoiled even more than before.

On this account, the liquid crystal television receiver of one embodiment of the present invention has, other than the original function for displaying image data such as broadcasting and video, a display mode (picture mode) for displaying a decorative image or the like while the liquid crystal television receiver is not used for the original function, so that the liquid crystal television receiver can be utilized as a part of the interior.

Further, the liquid crystal television receiver of one embodiment of the present invention is provided with a function for making a frame structure that is an actual part of the television receiver less conspicuous in displaying the decorative image or the like. This is for improving interior usability of the television receiver.

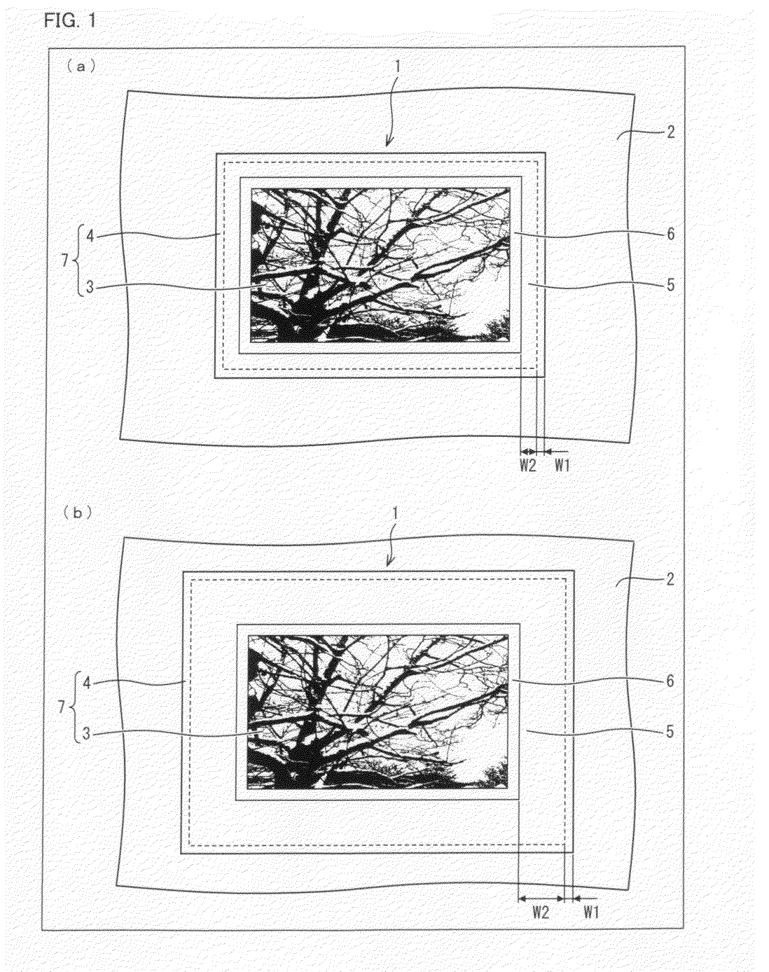

The following explains an embodiment of the present invention in detail as an example, with reference to FIGS. 1 to 9. Note that sizes, materials, relative positions and the like of respective components described in the present embodiment are not intended to limit the scope of the present invention to those described below, but merely exemplifications, unless specifically noted otherwise.

### Embodiment 1

### Color of Decorative Frame and Color of Frame Structure

FIGS. 1 to 5 are views each illustrating a liquid crystal television receiver 1 of an embodiment of the present invention in the picture mode, which each liquid crystal television receiver is hung on the wall 2.

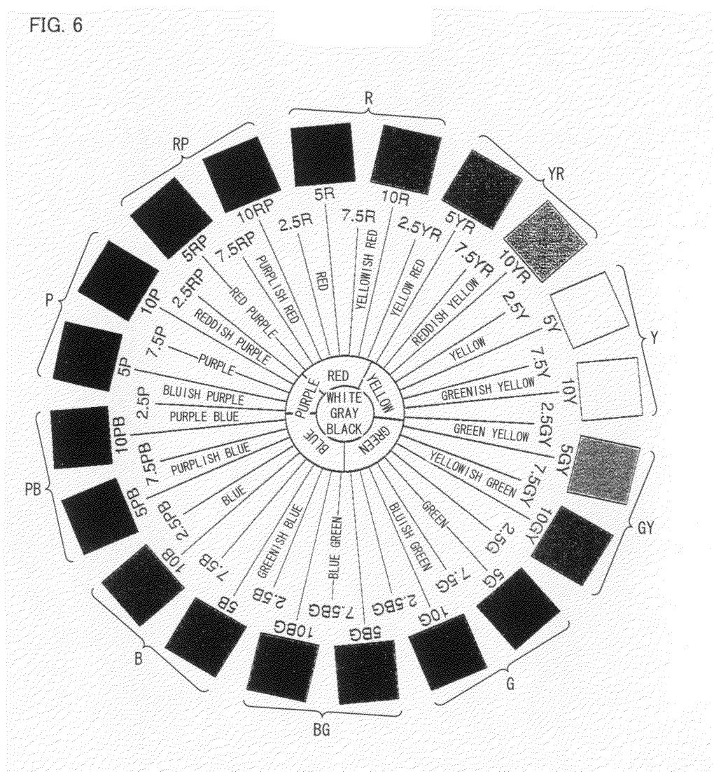

FIG. 6 is a view illustrating a Munsell hue circle having 20 hues.

In order to further improve the interior usability, the liquid crystal television receiver 1 of the present embodiment, while the decorative image or the like is displayed, has a color of the decorative frame 5 be a color in the same range as that of the frame structure 4, to make the frame structure 4 that is an actual part of the television receiver 1 less conspicuous.

A color in the same range denotes, in the present embodiment, all achromatic colors such as white, gray, and black in a case of an achromatic color. Meanwhile, in a case where the color is a chromatic color, the color in the same range denotes a same hue or its adjacent hue of the 10 hues on the outer side of the hue circle of the Munsell hue circle having 20 hues, illustrated in FIG. 6. It is also possible to use the 20 hues, and have the same hue or adjacent hues serve as the color in the same range. Use of the 20 hues allows the frame structure 4 to be further less conspicuous.

The following description further specifically explains this with reference to FIGS. 1 to 5, using the case where the frame structure 4 is of an achromatic color as an example.

Illustrated in (a) and (b) of FIG. 1 are each a liquid crystal television receiver 1 of an embodiment of the present invention in which the color of the frame structure 4 is white and a color in the same range as the color of the frame structure 4, i.e., white, is used as the color of the decorative frame 5.

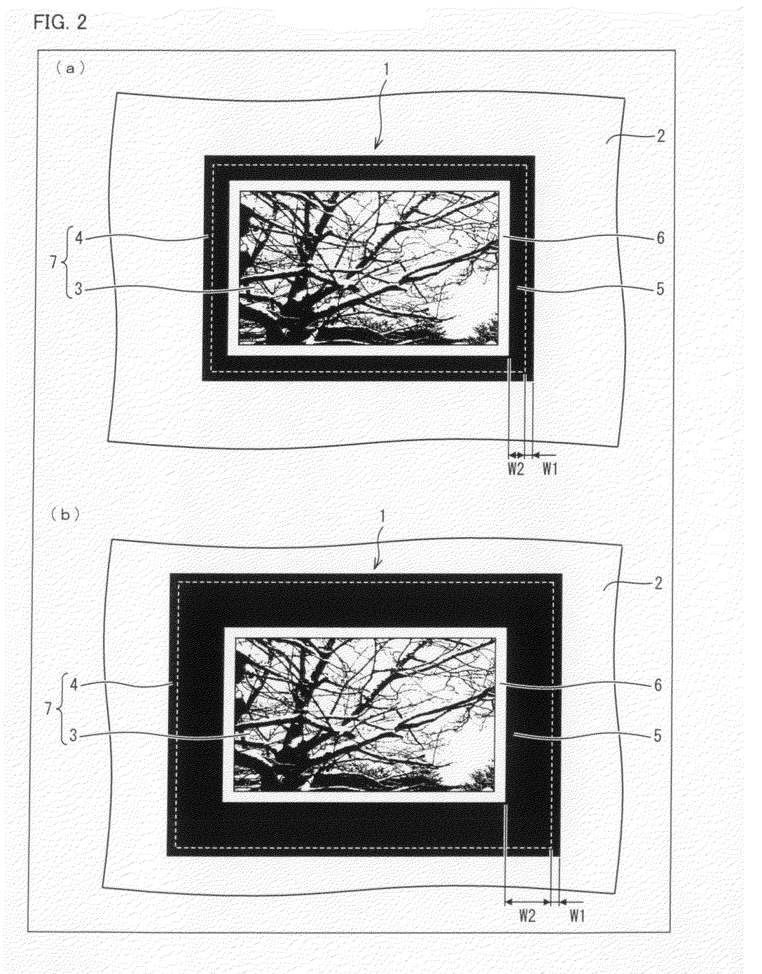

Each illustrated in (a) and (b) of FIG. 2 is a liquid crystal television receiver 1 of an embodiment of the present invention in which the color of the frame structure 4 is black and a color in the same range as the color of the frame structure 4, i.e., black, is used as the color of the decorative frame 5.

The dotted lines in FIGS. 1 and 2 indicate a borderline between the frame structure 4 and the decorative frame 5.

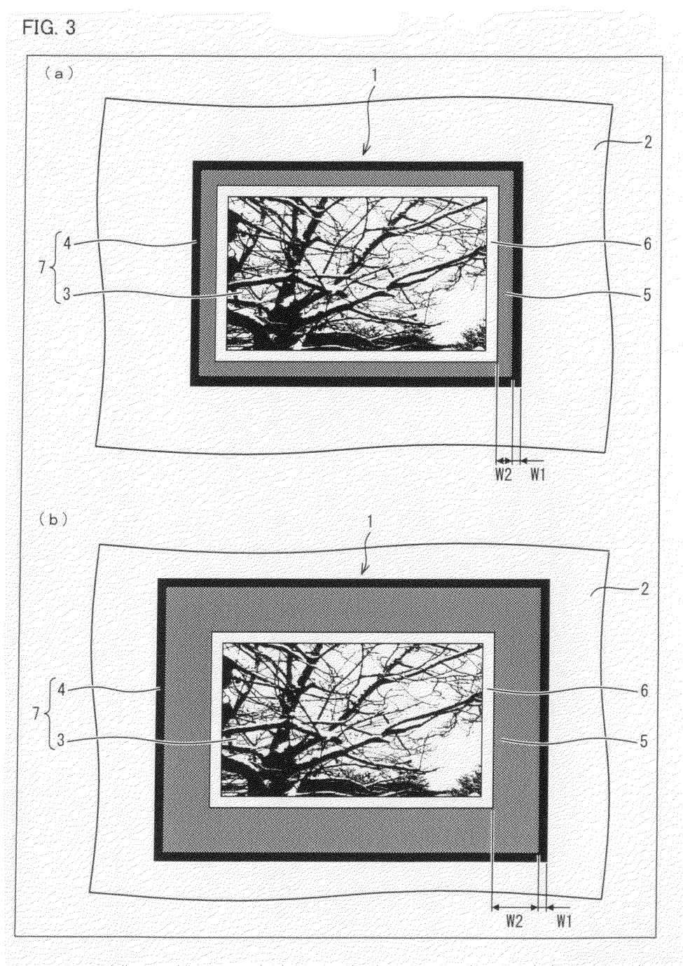

Each illustrated in (a) and (b) of FIG. 3 is a liquid crystal television receiver 1 of an embodiment of the present invention, in which the color of the frame structure 4 is black, and gray is used as the color of the decorative frame 5, which gray is a color in the same range as the color of the frame structure 4.

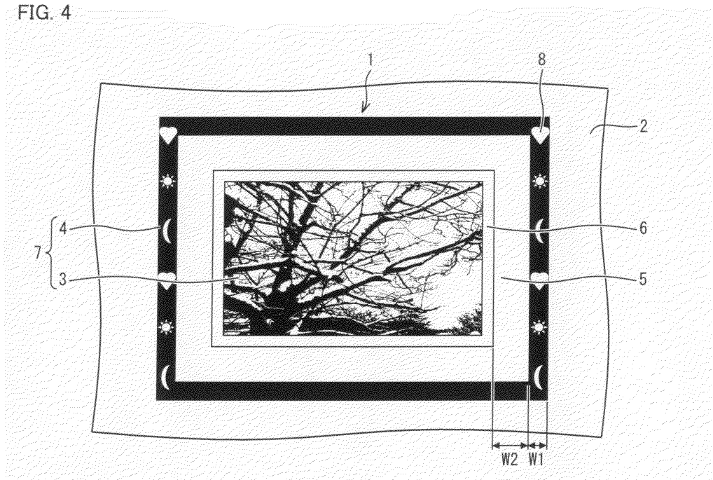

FIG. 4 illustrates a liquid crystal television receiver 1 of an embodiment of the present invention, in which the color of the frame structure 4 is black and includes a white pattern 8, and the color of the frame structure 4 or the color in the same range as the color of the pattern 8 is used as the color of the decorative frame 5.

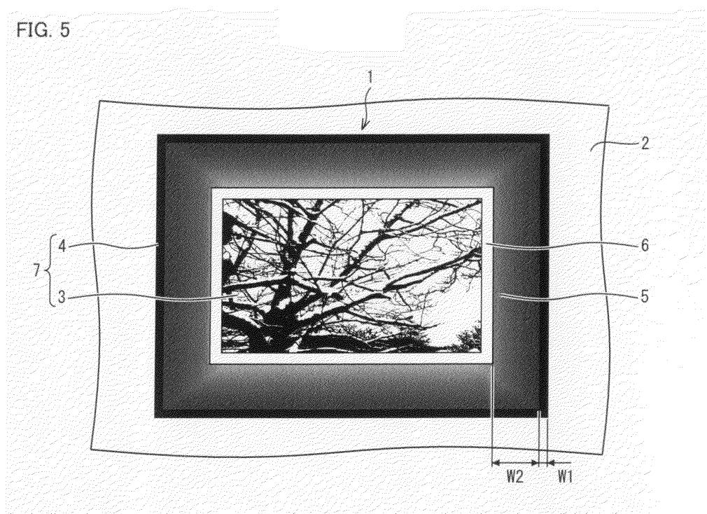

FIG. 5 illustrates a liquid crystal television receiver 1 of an embodiment of the present invention, in which a color of the frame structure 4 is black and the color of the decorative frame 5 is a gradation from white to black, which colors are ones in the same range.

The foregoing combinations are merely exemplifications for describing the embodiment of the present invention.

As described above, with the liquid crystal television receiver 1 of an embodiment of the present invention, while a display mode switching operation section 100 described later in detail is in the picture mode for displaying a decorative image, the image data that is image processed by the image data calculation section 80 is calculated and prepared, and the peripheral section of the decorative image displays a decorative frame 5 that is set in advance to include a color in the same range as the color of the frame structure 4.

The following description further explains in detail of a case where the frame structure 4 is of a chromatic color (drawings have been omitted).

For instance, when the frame structure 4 is of a red purple hue 5RP (Red Purple) in the Munsell hue circle having 20 hues as illustrated in FIG. 6, 5RP, 10P (Purple), and 10RP are either the same hue or an adjacent hue to the red purple hue, as illustrated in the Munsell hue circle having 20 hues in FIG. 6. Hence, the 5RP, 10P, and 10RP serve as the colors in the same range.

Therefore, with the liquid crystal television receiver 1 of an embodiment of the present invention, while the display mode switching operation section 100 described later in detail is in the picture mode for displaying a decorative image, image data that is image processed by the image data calculation section 80 is calculated and prepared, and the decorative frame 5 that is set in advance to include at least one color in the same range as the red purple hue 5RP, that is, the color of the frame structure 4 of the liquid crystal television receiver 1, is displayed in a peripheral section of the decorative image.

According to the configuration, the decorative frame 5 can be made to include a color in the same range as the color of the frame structure 4. Hence, it is possible make the frame structure 4 less conspicuous.

The above description deals with a configuration which uses the Munsell hue circle having 20 hues, however it is also possible in the present embodiment to use the Munsell hue circle having 10 hues.

With the Munsell hue circle having 10 hues as shown on the outer sides of the circumference in FIG. 6, for instance, 5Y (Yellow) and 10Y of the Munsell hue circle having 20 hues serve as Y, and 5GY (Green Yellow) and 10 GY of the Munsell hue circle having 20 hues serves as GY; consequently, the 20 hue becomes 10 hues.

Therefore, for example, in the case where the frame structure 4 is of a yellow hue Y, the yellow hue Y, the yellow red hue YR (Yellow Red), and the green yellow hue GY are the same hue or adjacent hues as illustrated in the Munsell hue circle having 10 hues in FIG. 6. Hence, Y, YR and GY serve as the colors in the same range.

As described above, according to the configuration that uses the Munsell hue circle having 10 hues, the color of the decorative frame 5 and the color of the frame structure 4 are either adjacent hues or are the same hue among the 10 hues of the Munsell hue circle. Hence, the frame structure 4 is made less conspicuous.

Moreover, the liquid crystal television receiver 1 of an embodiment of the present invention can also be configured in such a manner that the color of the decorative frame 5 and the color of the frame structure 4 are achromatic colors such as white, gray, black, and the like, which colors are in the same range.

According to the foregoing configuration, it is possible to attain a configuration that suits a black and white decorative image.

As described above, the present embodiment describes how to find a color that is in the same range by use of the Munsell hue circle illustrated in FIG. 6 in the case where the frame structure 4 is of a chromatic color. However, other methods may also be used. For instance, it is also possible to regard a color as a color in a same range in a case where the hues have a hue in common. More specifically, according to this method, colors in the same range as red include all colors that include red as its common hue, such as red, reddish purple, red purple, purplish red, yellowish red, yellow red, reddish yellow and the like.

Moreover, in the liquid crystal television receiver 1 of an embodiment of the present invention, the color of the same range preferably has a same color value.

According to the configuration, a color value, which is an attribute of color regarding relative brightness of an object surface, is the same. Hence, it is possible to further make the frame structure 4 less conspicuous.

<Width of Decorative Frame and Width of Frame Structure>

Each illustrated in (a) of FIG. 1, (a) of FIG. 2, and (a) of FIG. 3 is a viewable region 7 of the liquid crystal television receiver 1 in which its decorative frame 5 that is a part of a display region 3 has a width W2 twofold of a width W1 of its frame structure 4.

As illustrated in (a) of FIG. 1, (a) of FIG. 2, and (a) of FIG. 3, the viewable region 7 of an embodiment of the present invention includes the frame structure 4 and the display region 3. The frame structure 4 is an actual part of the liquid crystal television receiver 1 and essential in the configuration in view of durability of the liquid crystal television receiver 1. The display region 3 is on inner side of the frame structure 4 and displays an image.

Furthermore, the display region 3 includes a region for displaying a decorative image such as a painting or a photograph and a region for displaying the decorative frame 5 in a peripheral section of the decorative image.

While a decorative image is displayed in the display region 3 of an embodiment of the present invention, a decorative frame 5 is displayed on a peripheral section of the decorative image, in which the decorative frame has, for example, the width W2 that is not less than twofold of the width W1 of the frame structure 4.

Illustrated in (a) of FIG. 1, (a) of FIG. 2, and (a) of FIG. 3 are examples in which widths W1 in up-down and left-right directions of the frame structure 4 are of a same width, and widths W2 of the decorative frame 5 are also of a same width, in which widths W2 are twofold of the widths W1. However, the present invention is not limited to this, and the same applies in a case where the widths W1 of the frame structure 4 vary between each other.

For example, in a case where a liquid crystal television receiver of a 52 inch type is used, which upper frame structure, lower frame structure, left frame structure, and right frame structure of the frame structure 4 have a width of 41 mm, 72 mm, 43.5 mm, and 43.5 mm, respectively, the widths of the decorative frame 5 is set to be twofold of a corresponding width of the frame structure 4. As a result, the widths of the upper decorative frame, lower decorative frame, left decorative frame, and right decorative frame of the decorative frame 5 become 82 mm, 144 mm, 87 mm, and 87 mm, respectively. Meanwhile, the upper decorative frame may be set to have a same width as the lower decorative frame, as 144 mm, or all four sides may be set to have the same width as the lower decorative frame, as 144 mm.

Moreover, if the width of the decorative frame 5 is set so that the width is onefold of the frame structure 4, the width of the upper decorative frame, the lower decorative frame, the left decorative frame, and the right decorative frame in the decorative frame 5 becomes 41 mm, 72 mm, 43.5 mm, and 43.5 mm, respectively. Meanwhile, the upper decorative frame can be set to be the same as the lower decorative frame, as 72 mm, or all four sides can be set to be the same as the lower decorative frame, as 72 mm.

That is to say, in a case where the display mode switching operation section 100 described later in details is in a picture mode for displaying a decorative image, image data that is image processed by the image data calculation section 80 of the liquid crystal television receiver 1 of an embodiment of the present invention is calculated and prepared, and the decorative frame 5 having a width set in advance is to be displayed on the peripheral section of the decorative image.

According to the configuration, when a decorative image is displayed, both the frame structure 4 and the decorative frame 5 serve as the frame of the decorative image.

However, by having the width W2 of the decorative frame 5 be not less than onefold of the width W1 of the frame structure 4, for example twofold of the width W1 of the frame structure 4, the width W1 of the frame structure 4 becomes less conspicuous.

Namely, just the decorative frame 5 is conspicuous as the frame of the decorative image.

Therefore, it is possible to make the frame structure 4 less conspicuous while the decorative image is displayed, and achieve a liquid crystal television receiver 1 which can show a frame of the decorative image with a more real appearance.

Each illustrated in (b) of FIG. 1, (b) of FIG. 2, and (b) of FIG. 3 is a liquid crystal television receiver 1 of the embodiment of the present invention in the picture mode, which liquid crystal television receiver 1 is hung on the wall 2.

Each illustrated in (b) of FIG. 1, (b) of FIG. 2, and (b) of FIG. 3 is a view illustrating the viewable region 7 in which the width W2 of the decorative frame 5 is fivefold of the width W1 of the frame structure 4.

In the liquid crystal television receiver 1 of an embodiment of the present invention, the width W2 of the decorative frame 5 is fivefold of the width W1 of the frame structure 4.

As described above, the width W2 of the decorative frame 5 is not less than onefold, e.g., twofold of the width W1 of the frame structure 4, to make the width W1 of the frame structure 4 less conspicuous.

However, if the width W2 of the decorative frame 5 is too thick, proportion of the frame is too high area with respect to the size of the decorative image. This causes the viewer to feel awkwardness with the image, and the appearance is remarkably spoiled.

Hence, as in the configuration, by having the width W2 of the decorative frame 5 be not more than fivefold of the width W1 of the frame structure 4, it is possible to make the width W1 of the frame structure 4 less conspicuous, while further preventing the width W2 of the decorative frame 5 from being too wide. As a result, it is possible to achieve a liquid crystal television receiver 1 with which a good appearance is maintained.

In (b) of FIG. 1, (b) of FIG. 2, and (b) of FIG. 3, widths W1 of the frame structure 4 are of a same width, and widths W2 of the decorative frame 5 are also of a same width, in which widths W2 are fivefold of the widths W1. However the present invention is not limited to this, and the same applies in a case where the widths of the frame structure 4 vary between each other.

For example, in a case where a liquid crystal television receiver of a 65 inch type is used, which upper frame structure, lower frame structure, left frame structure, and right frame structure of the frame structure 4 have a width of 44.5 mm, 81 mm, 44.5 mm, and 44.5 mm, respectively, the widths of the decorative frame 5 is set to be fivefold of corresponding widths of the frame structure 4. As a result, the widths of the upper decorative frame, lower decorative frame, left decorative frame, and right decorative frame of the decorative frame 5 become 222.5 mm, 405 mm, 222.5 mm, and 222.5 mm, respectively. Meanwhile, the lower decorative frame may be set to have a same width as the upper decorative frame, as 222.5 mm, or the widths of the decorative frame 5 may be set within a range of onefold to fivefold of the widths of the frame structure 4. Moreover, the television receiver may include a function that allows the viewer to set the width of the decorative frame 5 to any width.

That is to say, in a case where the display mode switching operation section 100 described later is in the picture mode for displaying an decorative image, image data that is image processed by the image data calculation section 80 of the liquid crystal television receiver 1 of one embodiment of the present invention is calculated and prepared, and the decorative frame 5 having a width set in advance is to be displayed on the peripheral section of the decorative image.

Moreover, as described above, the width of the frame structure 4 of an embodiment of the present invention preferably ranges from not less than 5 mm to not more than 85 mm.

If the width of the frame structure 4 is not more than 5 mm, the frame structure 4 lacks in strength, thereby making it difficult to achieve a durable television receiver.

On the other hand, if the width of the frame structure 4 is not less than 85 mm, this spoils the good appearance of the television receiver.

Therefore, in the present embodiment, by using the frame structure 4 having a width ranging from not less than 5 mm but not more than 85 mm, it is possible to achieve a durable liquid crystal television receiver 1 while still maintaining its good appearance.

<Blank Image>

Furthermore, as illustrated in FIGS. 1 to 3, a blank image 6 is preferably inserted between the decorative image and the decorative frame 5 of the liquid crystal television receiver 1 of one embodiment of the present invention.

According to the configuration, by further inserting the blank image 6 between the decorative image and the decorative frame 5, it is possible to attain a display of the decorative image further close to a real picture which decorative image is displayed on the liquid crystal television receiver 1.

That is to say, for example, with a decorative image such as a woodblock print which appears more natural by having a blank in its peripheral section, use of this configuration allows attaining a display of the decorative image that is further close to a real picture.

This as a result attains a liquid crystal television receiver 1 that is capable of displaying the decorative image more like a real picture.

Moreover, for example, in a case where the decorative image is a painting, a blank painting paper can be displayed as the blank image 6, and in a case where the decorative image is a photograph, a blank printing paper can be displayed as the blank image 6.

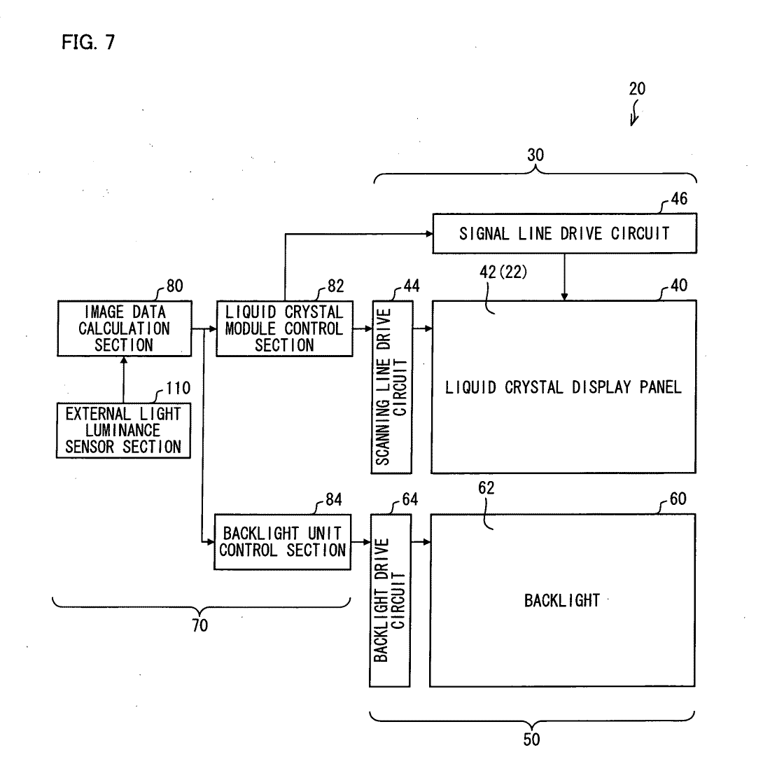

The following further explains in detail a liquid crystal display device used for the liquid crystal television receiver 1 of one embodiment of the present invention, with reference to FIGS. 7 to 9.

<Liquid Crystal Display Device>

FIG. 7 is a block diagram schematically illustrating a configuration of a liquid crystal display device 20 used for the liquid crystal television receiver 1 of one embodiment of the present embodiment.

As illustrated in FIG. 7, the liquid crystal display device 20 of the present embodiment includes, as its main components, a liquid crystal module 30, a backlight unit 50, and a sensor and control section 70. The following describes these one by one.

<Liquid Crystal Module>

First described is the liquid crystal module 30. The liquid crystal module 30 includes a liquid crystal display panel 40 having a screen 22 of the liquid crystal display device 20 and a scanning line driving circuit 44 and a signal line driving circuit 46. The scanning line driving circuit 44 and the signal line driving circuit 46 input signals for displaying an image on the liquid crystal display panel 40.

More specifically, a display surface 42 of the liquid crystal display panel 40 makes up the screen 22 of the liquid crystal display device 20. Further, the screen 22 of the liquid crystal display device 20 makes up the display area 3 in the liquid crystal television receiver 1 of one embodiment of the present invention.

Moreover, the liquid crystal display panel 40 has a plurality of scanning lines (not illustrated) drawn out from the scanning line driving circuit 44 and a plurality of signal lines (not illustrated) drawn out from the signal line driving circuit 46, which are disposed so that the scanning lines and signal lines form a matrix.

Namely, the liquid crystal display panel 40 of the present embodiment is configured to be what is called an active matrix type, and includes a plurality of pixels. Further, each of the pixels includes TFT (Thin Film Transistor) elements (not illustrated) as switching elements.

Moreover, the liquid crystal display panel 40 has what is called a color filter, whereby color display is possible.

Note that the configuration of the liquid crystal display panel 40 is not limited to the active matrix type, and various configurations are applicable.

<Backlight Unit 50>

Next described is the backlight unit 50. This backlight unit 50 is provided on a rear side of the liquid crystal module 30. The backlight unit 50 has (i) a backlight 60 including a light emitting surface 62 and (ii) a backlight driving circuit 64 for driving the backlight 60.

Moreover, the backlight unit 50 of the present embodiment is configured to allow what is called local dimming. In the embodiment, local dimming denotes attaining a different luminance per predetermined region in the light emitting surface.

One example of a configuration in which the local dimming is possible as such is a configuration in which a light guide plate, which is a constituent of the backlight 60, is divided into a plurality of sections, and a light source is disposed in each of the divided light guide plates. By independently controlling the light sources, luminance can be varied within the light emitting surface.

The configuration of the backlight unit 50 is not limited to the foregoing configuration. Namely, the backlight unit 50 does not need to be a configuration of the local dimming, and may be a configuration in which light of an even luminance is emitted within the light emitting surface. Moreover, even with the case where the backlight unit 50 is to be configured so as to allow the local dimming, a configuration different from the configuration in which the light guide plate is divided may be used.

Moreover, LED (Light Emitting Diode) of red, green, and blue colors can be used as the light source. Note that the light source is not limited to the LED, and for example, a fluorescent lamp such as a cold cathode fluorescent lamp (CCFL), or an organic EL and the like can also be used.

<Sensor and Control Section>

The following describes the sensor and control section 70. The sensor and control section 70 senses the external light luminance, and controls the liquid crystal module 30 and backlight unit 50 based on the sensed external light luminance.

More specifically, the sensor and control section 70 mainly includes an external light luminance sensor section 110 and an image data calculation section 80 connected to the external light luminance sensor section 110.

Further, the image data calculation section 80 is connected to (i) a liquid crystal module control section 82 that controls the liquid crystal module 30 and (ii) a backlight unit control section 84 that controls the backlight unit 50.

The liquid crystal module control section 82 is connected to the scanning line driving circuit 44 and signal line driving circuit 46 of the liquid crystal module 30, described above.

Moreover, the backlight unit control section 84 is connected to a backlight driving circuit 64 of the backlight unit 50 described above.

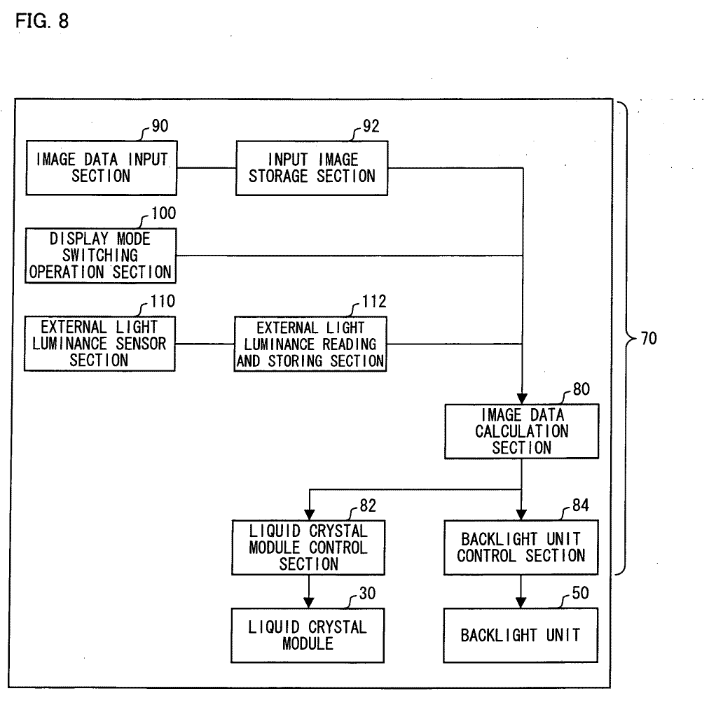

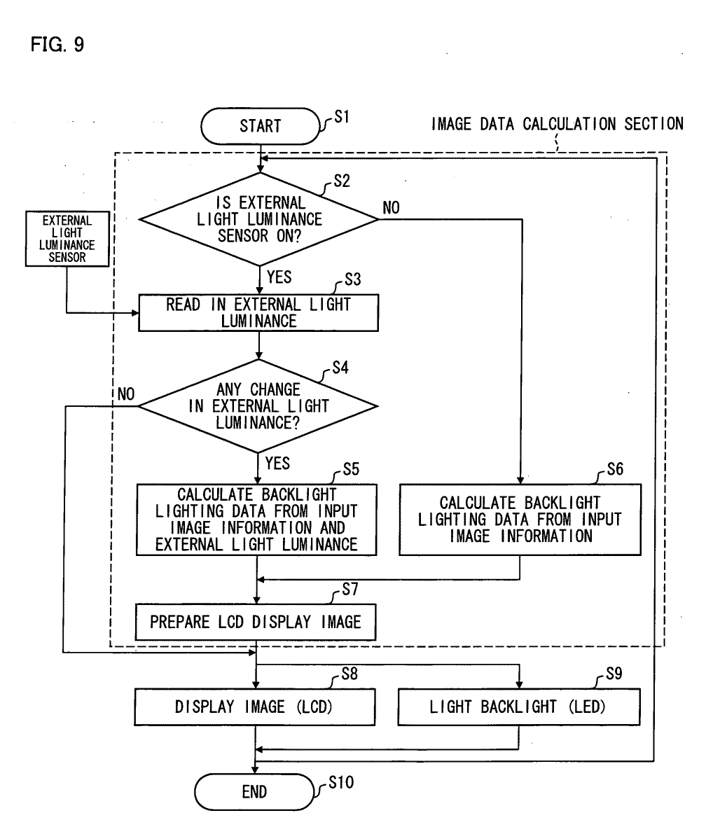

The following description more specifically explains the configuration of the sensor and control section 70 and its specific controlling method, with reference to FIGS. 8 and 9. The sensor and control section 70 and the specific controlling method thereof are relevant to a configuration for controlling a surface luminance of the display region 3 so that the decorative image can be displayed to look more real in the liquid crystal television receiver 1 of one embodiment of the present invention.

<Block Diagram of Luminance Control>

FIG. 8 is a block diagram related to luminance control in the liquid crystal display device 20 used for the liquid crystal television receiver 1 of one embodiment of the present invention.

FIG. 8 more specifically illustrates the configuration of the sensor and control section 70 described with reference to FIG. 7 above.

Namely, the image data calculation section 80, in addition to being connected to the external light luminance sensor section 110, is also configured to be capable of receiving data related to an image and information related to switching of a display mode.

<Image Data>

More specifically, the image data input section 90 is connected to the image data calculation section 80 via the input image storage section 92.

In the embodiment, the image data input section 90 is a section where input of a decorative image such as a painting or a photograph is received.

Moreover, the input image storage section 92 is a section in which image data of the decorative image inputted into the image data input section 90 is stored.

Note that an image of a television broadcasting is generally not stored into the input image storage section 92.

<Display Mode>

Moreover, the image data calculation section 80 is connected to a display mode switching operation section 100.

In the present embodiment, the display mode switching operation section 100 is an operation section for switching the display mode between the regular television mode and the picture mode in which the decorative image is displayed, of the liquid crystal display device 20 used for the liquid crystal television receiver 1 of one embodiment of the present invention.

The television mode denotes a display mode in which a dynamic image of television broadcasting or video reproduction is displayed on the liquid crystal display device 20. Namely, the television mode denotes a display mode for use of the liquid crystal display device 20 as a regular television.

On the other hand, the picture mode denotes a display mode that causes display of a decorative image such as a painting or a photograph on a screen in terms of appearance, while the liquid crystal display device 20 is not used as the television mode.

<Luminance Sensor>

Moreover, the image data calculation section 80 is connected to the external light luminance sensor section 110 described above with reference to FIG. 7, via the external light luminance reading and storing section 112.

In the embodiment, the external light luminance sensor section 110 has a sensor for measuring luminance in a location in the vicinity of a located position of the liquid crystal display device 20.

The external light luminance sensed by the sensor is read and thereafter stored by the external light luminance reading and storing section 112.

As described above, the sensor measures the external light luminance, and this measured result is stored. Consequently, information related to brightness in a viewing environment of the liquid crystal display device 20 is obtained, which information serves as one element used for controlling screen luminance of the liquid crystal display device 20.

<Image Data Calculation Section>

Based on the image data, the display mode, and external light luminance information, the image data calculation section 80 calculates image data and luminance information, which are to be outputted to the liquid crystal module control section 82 and the backlight unit control section 84.

Note that, as described above with reference to FIG. 7, the liquid crystal module control section 82 and the backlight unit control section 84 are connected to the liquid crystal module 30 and the backlight unit 50, respectively.

<Flowchart>

Next described is a procedure carried out for luminance control of the screen in the liquid crystal display device 20 used for the liquid crystal television receiver 1 of one embodiment of the present invention, with reference to FIG. 9. Descriptions are provided one by one.

(S1)

First, the procedure starts by having a user of the liquid crystal display device 20, for example a viewer of the liquid crystal television receiver 1, to selects the picture mode as the display mode.

(S2)

The image data calculation section 80 determines whether or not sensing of the external light luminance, namely, sensing of brightness of a viewing environment is ON (external light luminance sensor is ON).

When the external light luminance sensor is ON, the procedure proceeds to S3, and the sensed external light luminance is read in.

On the other hand, if the external light luminance sensor is not ON, the procedure proceeds to S6. Namely, as described above, in S6, lighting data of the backlight (that is, the backlight lighting data) as a light source is calculated from input image information which is information other than the external light luminance.

(S3)

Upon determination in S2 that the external light luminance sensor is ON, the image data calculation section 80 reads in an external light luminance that is sensed by the sensor.

More specifically, the external light luminance sensed by the sensor of the external light luminance sensor section 110 is inputted into the image data calculation section 80 via the external light luminance reading and storing section 112.

(S4)

Thereafter, in S4, the image data calculation section 80 determines whether or not a change has occurred in the inputted external light luminance.

If it is determined that the external light luminance has changed, the procedure proceeds to S5.

On the other hand, if it is determined that no change has occurred in the external light luminance, there is no need to recalculate the lighting data of the backlight. In such a case, the procedure proceeds to S8 and S9 described later.

Note that the foregoing case relates to a case where the external light luminance is read in for a second or more times in a loop processing, and at a time when the external light luminance is read in for the first time, it is determined that the external light luminance has changed, and therefore proceeds to S5.

(S5)

If it is determined in S4 that the external light luminance has changed, and also when carrying out the loop processing for the first time, the lighting data of the backlight is calculated based on the input image information and the external light luminance that has been read in. More specifically, the lighting data of the backlight is calculated so that the luminance of the screen is to be a predetermined luminance.

(S6)

Next describes S6. As described above, S6 is carried out in the case where the external light luminance sensor is not ON in S2.

This S6 is as similar to S5 in the point that the lighting data of the backlight is calculated. However, it is different from S5 in that the external light luminance is not included in the data on which the calculation is based.

This is because in the case where S6 is to be carried out, the external light luminance sensor is not ON; hence no external light luminance is sensed.

Subsequently, predetermined lighting data of the backlight (luminance) is derived in accordance with the decorative image. The luminance at this time is set to be lower than that of the television mode.

(S7)

The following describes S7. In S7, an image to be outputted to the liquid crystal module (image to be displayed on the panel) is prepared correlating to the backlight lighting data calculated in S5 or S6.

(S8, S9)

Based on the Data Calculated and Generated in the Steps up to S7, an image is displayed on the liquid crystal module and a backlight is lighted by the backlight unit.

This allows display of an image with a preferred screen luminance.

(S10)

Finally, the Procedure Ends at S10.

With the present procedure, loop processing (repeated processing) can be carried out; for example, after elapse of a predetermined time since an image is displayed, a value of the external light luminance sensor is read in again, to again calculate the lighting data of the backlight. More specifically, it is possible to have the procedure return to S2 again after carrying out S8 and S9.

By allowing such a loop processing, it is possible to achieve a high quality display further suitable for a current viewing environment such as the external light luminance, by appropriately sensing a change in the viewing environment.

Moreover, with the loop processing, calculation of the lighting data of the backlight and the like may be omitted if there is no change in the external light luminance.

More specifically, for example, in a case where it is determined in S4 that no change has occurred to the external light luminance as described above, there is no need to recalculate the lighting data of the backlight, thereby allowing omission of carrying out the processes in S5 and S7 again. Thereafter, an image is displayed on the liquid crystal module and a backlight is lighted in the backlight unit, based on the previous lighting data of the backlight and LCD display image data.

Note that the steps from S2 to S7 are carried out by the image data calculation section 80 of the sensor and control section 70, as described above.

Moreover, with the television mode, a usual image data calculation can be carried out.

Furthermore, also with the television mode, it is possible to allow variation in a display luminance depending on the external light luminance by use of an external light luminance sensor. In this case, one external light luminance sensor can commonly serve as the external light luminance sensor in the television mode and the external light luminance sensor in the picture mode.

That is to say, the external light luminance sensor used for the television mode can be shared to serve also as the external light luminance sensor for the picture mode; no additional component is required as the external light luminance sensor for the picture mode.

<Surface Luminance of Display Region>

Note that in the liquid crystal television receiver 1 of one embodiment of the present invention, the surface luminance of the display region 3 in which the decorative image is displayed is preferably not more than 50 cd/m².

Moreover, in the liquid crystal television receiver 1 of one embodiment of the present invention, the surface luminance of the display region 3 in which the blank image 6 is displayed is preferably not more than 50 cd/m².

According to the configuration, the surface luminance of the display region 3 in which the decorative image is displayed is very low; hence, it is possible to cause the viewer of the liquid crystal television receiver 1 to sense the color as not a luminous color but a reflected color. In other words, it is possible to cause the user to perceive the image as not an image displayed but as an actual painting that is drawn or painted on a piece of paper or the like.

Moreover, the display region 3 of the blank image 6 displayed between the decorative image and the decorative frame 5 displayed in a peripheral section of the decorative image can be set at a very low surface luminance.

The above configuration makes it possible to realize a liquid crystal television receiver 1 capable of displaying the decorative image and the blank image 6 so that the decorative image and the blank image 6 appear more real.

The liquid crystal television receiver 1 of one embodiment of the present invention preferably has the surface luminance of not more than 30 cd/m².

According to the above configuration, the surface luminance is not more than 30 cd/m². Accordingly, even in a case were the external light luminance is low, for example not more than 100 cd/m², it is possible to cause the decorative image and the blank image 6 displayed in the display area 3 to appear real to a viewer as though the images were drawn on paper or the like.

As a result, it is possible to achieve a liquid crystal television receiver 1 that can display the decorative image and the blank image 6 so that these images look more real even in a dark space.

Namely, with the liquid crystal display device 20 used for the liquid crystal television receiver 1 of one embodiment of the present invention, a preferable surface luminance of the screen 22 while its display mode is in the picture mode for displaying a decorative image, is not more than 50 cd/m², particularly not more than 30 cd/m².

This surface luminance can be said as an extremely low surface luminance, taking in consideration that surface luminance of a regular television receiver or the like is at least 450 cd/m², and that displays which are held down in surface luminance such as ones used for theater screens still have a surface luminance of at least 200 cd/m².

Note that, in attaining the screen luminance, the luminance of the backlight is set at 1500 cd/m². Furthermore, this backlight luminance is more preferably 1000 cd/m².

Further, if the surface luminance is controlled together with the sensing of the external light luminance, as shown in the flowchart, it is possible to carry out thorough control of the surface luminance in accordance with the viewing environment, particularly the external light luminance.

More specifically, for example, there are cases where a viewing environment in Japan and other Asian countries is different from those of Europe and the Americas. Caused by these differences in viewing environments, an optimum surface luminance may vary.

Namely, the viewing environment in Japan and other Asian countries is generally bright, and a screen is easily seen with a relatively high surface luminance.

More specifically, the viewing environment in Japan and the like use direct lighting as lighting, and often use fluorescent lamps for these lightings. Further, external light luminance is often around 200 lx to 300 lx, and a front of the screen is often around 100 lx.

In a case where a painting or the like is displayed in such a viewing environment, the surface luminance is preferably in a range from 20 cd/m² to 30 cd/m². With such a surface luminance, it is possible to avoid the picture be sensed as an illuminant, and lessen the presence as the liquid crystal television receiver 1.

Moreover, in a case where a photograph or the like is displayed, the surface luminance can be 100 cd/m². With such a surface luminance, it is easy to maintain a degree of vividness and contrast, thereby making it suitable to use the liquid crystal television receiver 1 as a photograph display device (photo viewer).

On the other hand, the preferable surface luminance differs from this in the viewing environment of Europe and the Americas.

Namely, the viewing environment of Europe and the Americas is generally dark, and a screen is easily seen with a relatively dark surface luminance.

More specifically, the viewing environment in Europe and the like use indirect lighting as the lighting, and incandescent lamps are often used for these lightings. Further, the external light luminance (in-room luminance) in such cases is around 10 lx to 30 lx, and a front of the screen is around 10 lx to 30 lx.

In a case where a painting or the like is displayed in such a viewing environment, the surface luminance is preferably in a range of 10 cd/m² to 15 cd/m².

Meanwhile, in a case where a photograph or the like is displayed, the surface luminance is preferably 50 cd/m².

Moreover, even in a case where the liquid crystal television receiver 1 is provided at a same location, there are case where the external light luminance varies in accordance with the on and off of lighting and also the time. As a result an optimum surface luminance also varies together with such a change.

If the surface luminance is set so that it is automatically set to an optimum value in accordance with the external light luminance, it becomes easy for the viewer to view a screen that has an optimum luminance at all times.

Further, according to the flowchart described with reference to FIG. 9 for example, it is possible to automatically control the surface luminance.

As described above, the embodiment of the present invention describes, as the television receiver, a liquid crystal television receiver whose display region is a screen of a liquid crystal display device, however the television receiver of the present invention is not limited to this configuration; the television receiver may be any television receiver whose display region is a screen of various display devices, such as PDP (Plasma Display Panel), CRT (Cathode Ray Tube), organic EL, or the like.

The invention being thus described, it will be obvious that the same way may be varied in many ways. Such variations are not to be regarded as a departure from the spirit and scope of the invention, and all such modifications as would be obvious to one skilled in the art are intended to be included within the scope of the following claims.

### INDUSTRIAL APPLICABILITY

The present invention allows display of a decorative image such as a painting as though the decorative image had a real frame. Hence, the present invention is suitably used for a television receiver of a large screen which requires to have a good appearance, to serve as part of an interior.

### REFERENCE SIGNS LIST

1 liquid crystal television receiver (television receiver)
3 display region
4 frame structure
5 decorative frame
6 blank image
W1 width of frame structure
W2 width of decorative frame

1. A television receiver comprising:
a frame structure; and
a display region surrounded by the frame structure, displaying an image,
the display region, while displaying a decorative image, displaying a decorative frame on a peripheral section of the decorative image,
the decorative frame including at least one color that is in a same range as a color of the frame structure.

2. The television receiver according to claim 1, wherein:
the color that is in a same range is a hue adjacent in position on a Munsell hue circle having ten hues, from among the ten hues in the Munsell hue circle.

3. The television receiver according to claim 1, wherein:
the color that is in a same range is a same hue on a Munsell hue circle having ten hues, from among the ten hues in the Munsell hue circle.

4. The television receiver according to claim 1, wherein:
the color that is in a same range is an achromatic color.

5. The television receiver according to claim 1, wherein:
the color that is in a same range has a same color value.

6. The television receiver according to claim 1, wherein:
the decorative frame has a width of not less than onefold of a width of the frame structure.

7. The television receiver according to claim 6, wherein:
the width of the decorative frame is not more than fivefold of the width of the frame structure.

8. The television receiver according to claim 1, wherein:
the frame structure has a width in a range from not less than 5 mm to not more than 85 mm.

9. The television receiver according to claim 1 wherein:
between the decorative image and the decorative frame, a blank image is further displayed.

10. The television receiver according to claim 1, wherein:
the surface luminance of the display region in which the decorative image is displayed is not more than 50 cd/m².

11. The television receiver according to claim 9, wherein:
the surface luminance of the display region in which the blank image is displayed is not more than 50 cd/m².

12. The television receiver according to claim 10, wherein:
the surface luminance is not more than 30 cd/m².

13. A method for driving a television receiver including: a frame structure; and a display region surrounded by the frame structure, displaying an image,
said method comprising:
causing the display region to display, while the display region displays a decorative image, a decorative frame on a peripheral section of the decorative image; and
causing the decorative frame to include at least one color that is in a same range as a color of the frame structure.

14. The method according to claim 13 for driving a television receiver, wherein:
the color that is in a same range is to be a hue adjacent in position on the Munsell hue circle having ten hues, from among the ten hues in the Munsell hue circle.

15. The method according to claim 13 for driving a television receiver, wherein:
the color that is in a same range is to be a same hue on a Munsell hue circle having ten hues, from among the ten hues in the Munsell hue circle.

16. The method according to claim 13 for driving a television receiver, wherein:
the color that is in a same range is to be an achromatic color.

17. The method according to claim 13 for driving a television receiver, wherein:
the color that is in a same range is to have a same color value.

18. The method according to claim 13 for driving a television receiver, wherein:
the decorative frame is to have a width of not less than onefold of a width of the frame structure.

19. The method according to claim 18 for driving a television receiver, wherein:
the width of the decorative frame is to be not more than fivefold of the width of the frame structure.

20. The method according to claim 13 for driving a television receiver, wherein:
between the decorative image and the decorative frame, a blank image is further displayed.

21. The method according to claim 13 for driving a television receiver, wherein:
the surface luminance of the display region in which the decorative image is displayed is to be not more than 50 cd/m².

22. The method according to claim 20 for driving a television receiver, wherein:
the surface luminance of the display region in which the blank image is displayed is to be not more than 50 cd/m².

23. The method according to claim 21 for driving a television receiver, wherein:
the surface luminance is to be not more than 30 cd/m².

24. The television receiver according to claim 11, wherein:
the surface luminance is not more than 30 cd/m².

25. The method according to claim 22 for driving a television receiver, wherein:
the surface luminance is to be not more than 30 cd/m².
